(19) United States
(12) Patent Application Publication
(10) Pub. No.: US 2025/0222567 A1
(43) Pub. Date: Jul. 10, 2025

(54) WRENCH

(71) Applicant: Honda Motor Co., Ltd., Tokyo (JP)

(72) Inventors: Rob Zimmerman, West Liberty, OH (US); Shane M. Englert, Sunbury, OH (US)

(21) Appl. No.: 18/405,963

(22) Filed: Jan. 5, 2024

(51) Int. Cl. B25B 13/08

(52) U.S. Cl. CPC B25B 13/08

(57) ABSTRACT

A wrench includes an elongated body having a first end face and an inner surface defining an elongated channel extending from the first end face to the second end face. The elongated body includes a first body portion having an inner surface with a shape complimentary to that of the nut and a second body portion having an inner diameter smaller than an inner diameter of the first body portion defining a seat therebetween. The elongated body also defines a cut-out extending from an outer surface to the inner surface along an entire length of the elongated body to enable an insertion of the wrench over a pipe and a nut. Moreover, a distance of the seat from the first end face is selected to provide a visual indication of completion of the hand tightening of the nut when the first end face contacts a modulator.

### BACKGROUND

The disclosed subject matter relates, generally, to a wrench. More particularly, the disclosed subject matter relates to a hand operated wrench suitable for coupling a pipe to a modulator.

Brake pipe nuts are sometimes hard to thread in by hand, especially when wearing gloves, to engage the brake pipes with a brake manifold/modulator. Moreover, the depth gauges are used to determine if the nuts have been properly assembled, leading to increased time of assembly.

### SUMMARY

In accordance with one embodiment of the present disclosure, a wrench for hand tightening a nut arranged surrounding a pipe to assemble the pipe to a modulator is disclosed. The wrench comprises an elongated body having a first end face, a second end face arranged opposite to the first end face, an outer surface and an inner surface defining an elongated channel extending from the first end face to the second end face. Further, the elongated body includes a first body portion extending from the first end face towards the second end face. An inner surface of the first body portion includes a shape complimentary to that of the nut. The elongated body further includes a second body portion extending from the first body portion towards the second end face. Moreover, an inner diameter of the second body portion is smaller than an inner diameter of the first body portion defining a seat at an interface of the first body portion and the second body portion. Also, the elongated body defines a cut-out extending from the outer surface to the inner surface of the elongated body along an entire length of the elongated body to enable an insertion of the wrench over the pipe and the nut. Furthermore, a distance of the seat from the first end face is selected to provide a visual indication of completion of the hand tightening of the nut when the first end face contacts the modulator during tightening of the nut.

In accordance with another embodiment of the present disclosure, a method for coupling a brake pipe to a brake modulator is provided. The method comprises inserting the brake pipe inside a hole of the brake modulator with a nut, for coupling the brake pipe to the brake modulator, positioned over the brake pipe and outside the brake modulator. The method also includes engaging a wrench to the brake pipe and the nut. The wrench includes an elongated body having a first end face, a second end face arranged opposite to the first end face, an outer surface and an inner surface defining an elongated channel extending from the first end face to the second end face. The elongated body further includes a first body portion extending from the first end face towards the second end face, and an inner surface of the first body portion includes a shape complimentary to that of the nut. The elongated body further includes a second body portion extending from the first body portion towards the second end face. Moreover, an inner diameter of the second body portion is smaller than an inner diameter of the first body portion defining a seat at an interface of the first body portion and the second body portion. Also, the elongated body defines a cut-out extending from an outer surface to the inner surface of the elongated body along an entire length of the elongated body. The wrench is engaged with the brake pipe such that the brake pipe extends through the channel and the nut is arranged inside the channel and abutting the seat. The method further includes rotating the wrench, by hand, to tighten the nut till the first end face of the wrench contacts the brake modulator.

In accordance with yet a further embodiment of the present disclosure a wrench for hand tightening a nut arranged surrounding a pipe to assemble the pipe to a modulator is disclosed. The wrench comprises an elongated body having a first end face, a second end face arranged opposite to the first end face, an outer surface and an inner surface defining an elongated channel extending from the first end face to the second end face. The elongated body further includes a first body portion extending from the first end face towards the second end face, and an inner surface of the first body portion includes a shape complimentary to that of the nut. The elongated body also includes a second body portion extending from the first body portion towards the second end face. An inner diameter of the second body portion is smaller than an inner diameter of the first body portion defining a seat at an interface of the first body portion and the second body portion. The elongated body defines a cut-out extending from an outer surface to the inner surface of the elongated body along an entire length of the elongated body to enable an insertion of the wrench over the pipe and the nut. Further, a distance of the seat from the first end face is selected to provide a visual indication of a completion of the hand tightening of the nut when the first end face contacts the modulator during tightening of the nut. Moreover, a portion of the outer surface of the elongated body defines a knurled surface that extends from the second end face towards the first end face.

### BRIEF DESCRIPTION OF THE DRAWINGS

Certain embodiments of the present disclosure will be better understood from the following description taken in conjunction with the accompanying drawings in which:

FIG. 1 is a perspective view of a pipe coupled to a modulator with a wrench positioned over a nut coupling the pipe with the modulator, in accordance with one embodiment of the present disclosure;

FIG. 2 is a side perspective view of the wrench, in accordance with one embodiment of the present disclosure;

FIG. 3 is a bottom perspective view of the wrench of FIG. 2, in accordance with one embodiment of the present disclosure; and

FIG. 4 is a top perspective view of the wrench of FIG. 2, in accordance with one embodiment of the present disclosure.

### DETAILED DESCRIPTION OF EXEMPLARY EMBODIMENTS

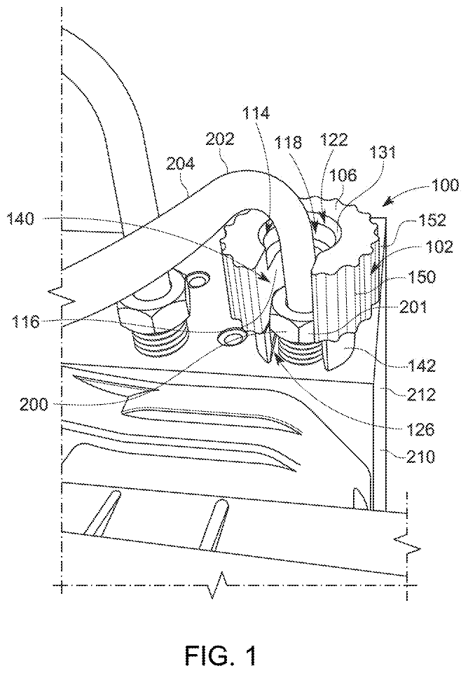

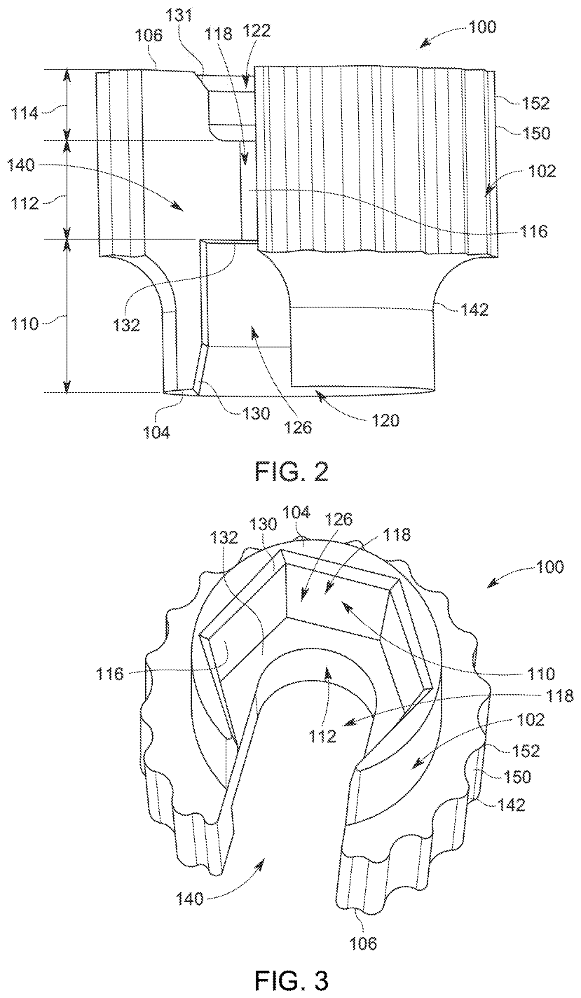

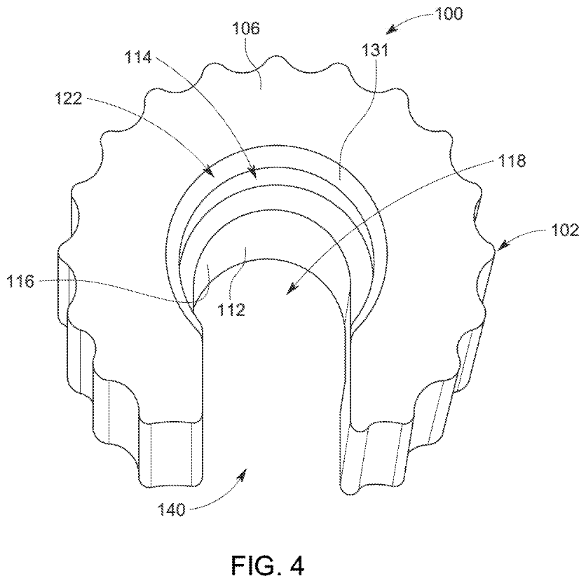

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows. Embodiments are hereinafter described in detail in connection with the views and examples of FIGS. 1-4, wherein like numbers indicate the same or corresponding elements throughout the views.

Referring to FIG. 1, a wrench 100 suitable for hand tightening a nut 200 arranged on a pipe 202, for example, a brake pipe 204, to couple/engage the pipe 202 to a modulator 210, for example, a brake modulator 212 is shown. The brakes modulator 210 may include a brake valve manifold or any other brake structure that facilitates control of brake fluid to the brakes. As shown in FIGS. 1-4, the wrench 100 includes an elongated body 102 having a first end face 104 and a second end face 106 arranged opposite to the first end face 104. Further, the elongated body 102 includes a first body portion 110 extending from the first end face 104 towards the second end face 106 and a second body portion 112 extending from the first body portion 110 towards the second end face 106. In some embodiments, the elongated body 102 also includes a third body portion 114 extending from the second body portion to the second end face 106. Accordingly, the second body portion 112 is arranged between the first body portion 110 and the third body portion 114. As can be seen, the elongated body 102 includes an inner surface 116 that defines a channel 118 extending from the first end face 104 to the second end face 106 with a first opening 120 of the channel 118 defined at the first end face 104 and second opening 122 of the channel 118 defined at the second end face 106. Accordingly, the elongated body 102 is a hollow body.

Moreover, the first body portion 110 is structured to receive and engage with the nut 200. For so doing, the first body portion 110 includes a cavity 126 that is defined by a portion of the inner surface 116 associated to the first body portion 110. Accordingly, the cavity 126 forms a part of the channel 118. The cavity 126 extends from the first end face 104 to the second end portion 112 and including a shape complimentary to that of an outer surface of the nut 200 . . . . For example, in the illustrated embodiment, shown in FIG. 1, the nut 200 is a hexagonal nut 201 and accordingly the portion of the inner surface 116 associated with the first body portion 110 includes a shape complimentary to that of the hexagonal nut 201. Further, the inner surface 116 includes a first chamfer 130 arranged proximate to the first end face 104 and extending from the first end face 104 in a longitudinal direction. As shown, the first chamfer 130 tapers radially inwardly in the longitudinal direction from the first end face 104. Similarly, the inner surface 116 defines/includes a second chamfer 131 extending from the second end face 106 towards the first end face 104. As shown, the second chamfer 131 tapers radially inwardly in the longitudinal direction from the second end face 104 and is arranged between the second end portion 112 and the second end face 106. The first chamfer 130 and the second chamfer 131 facilitate an easy removal and disengagement of the wrench 100 from the nut 200 and the pipe 202 upon tightening of the nut 200 with the modulator 210.

Further, an inner diameter of the first body portion 110 i.e., a size of the cavity 126 is larger than an inner diameter of the second body portion 112 i.e., inner diameter of a portion of the channel 118 associated with the second body portion 112. Accordingly, a seat 132 is defined at an interface/junction of the first body portion 110 and the second body portion 112. It may be appreciated that the wrench 100 is engaged with the nut 200 such that an end face of the nut 200 is arranged abutting the seat 132. Further, a distance of the seat 132 from the first end face 104 is selected such that nut 200 is tightened with the modulator 210 to a desired level when the first end face 104 of the wrench 100 contacts the modulator, thereby providing a visual indication of completion of the hand tightening of the nut 200. Also, it may be appreciated that the inner diameter of the second body portion 112 is selected such that the inner diameter corresponds to an outer diameter of the pipe 202 to be coupled with the modulator 210, and is either equal to an outer diameter of the pipe 202 or slightly larger than the outer diameter of the pipe 202. Also, in some embodiments, the inner diameter of the second body portion 112 is smaller than an inner diameter of the third body portion 114. In some scenarios, the third body portion 114 may be omitted.

In some embodiments, to position the wrench 100 surrounding the pipe 202 and/or the nut 200, the elongated body 102 defines a cut-out 140 extending from the first end face 104 to the second end face 106 in the longitudinal direction of the elongated body 102, and extending from an outer surface 142 of the elongated body 102 to the inner surface 116 of the elongated body 102. Moreover, a width of the cut-out 140 is substantially equal to or larger than the outer diameter of the pipe or a length of side of the nut 200 so as to enable an easy insertion of the pipe 202 and/or the nut 200 inside the wrench 100 and removal of the wrench 100. To facilitate a gripping of the wrench by a technician, the elongated body 102 includes a skirt portion 150 extending radially outwardly from the second body portion 112 and the third body portion 114. A portion of the outer surface 142 corresponding to the skirt portion 150 is a knurled surface 152 to enable improved gripping and reduced slippage of hand from the wrench 100. As shown, an outer diameter of the elongated body 102 corresponding to the skirt portion 150 is greater than the outer diameter of the rest of the elongated body 102, and the skirt portion 150 extends from the second end face 106 towards the first end face 104 and may be arranged at a distance from the first end face 104.

A method for coupling the brake pipe 204 to the brake modulator 212 using the wrench 100 is now described. For coupling the brake pipe 204 with the brake modulator 212, a technician inserts/positions the nut 200 surrounding/over the brake pipe 204 by extending the brake pipe 204 through the nut 200. Thereafter, the technician inserts the free end of the brake pipe 204 inside a hole of the brake modulator 212 with the nut 200 positioned over the brake pipe 204 and outside the brake modulator 212. Subsequently, the technician engages the wrench 100 with the nut 200 and the brake pipe 204. For so doing, in an embodiment, the technician may engage the wrench 100 with the brake pipe 204 by inserting the brake pipe 204 inside the channel 118 through the cut-out 140 such that the nut 200 is arranged between the brake modulator 212 and the first end face 104 of the wrench 100. After engaging the wrench 100 with the brake pipe 204 and positioning the wrench 100 surrounding the brake pipe 204, the technician may displace the wrench 100 towards the brake modulator 212 relative to the nut 200 to position the nut 200 abutting the seat 132. In some embodiments, the technician may position the wrench 100 around the nut 200 and the brake pipe 204 by inserting both the nut 200 and the brake pipe 204 inside the channel 118 via the cut-out 140 such that the nut 200 is arranged inside the cavity 126 and abutting the seat 132.

Upon engaging the wrench 100 with the nut 200, the technician holds the knurled surface 152 and rotates the wrench 100, by hand, and tightens the nut 200 till the first end face 104 of the wrench 100 contacts the brake modulator 212. The contact of the first end face 104 of the wrench 100 provides a visual indication to the technician about a completion of the initial engagement of the nut 200 with the brake pipe 204 and the brake modulator 212. In this manner, the wrench 100 enables an easy initial coupling of the nut 200 positioned over the brake pipe 204 with the brake modulator 212 with the hand even while the technician is wearing gloves and engage with the brake pipe 204 with the brake modulator 212.

Thereafter, the technician may remove/disengage the wrench 100 from the brake pipe 204 and the nut 200 and uses a torque wrench to apply necessary torque to securely engage the nut 200 with the brake modulator 212, completing the coupling of the brake pipe 204 with the brake modulator 212 via the nut 200. To remove/disengage the wrench 100, technician may displace the wrench 100 in a direction away from the brake modulator 212 such that nut 200 is positioned outside the channel 118 and then moves the wrench 100 such that the brake pipe 204 moves outside the channel 118 through the cut-out 140. In some embodiments, the wrench 100 is disengaged from the nut 200 and the brake pipe 204 simultaneously by moving the wrench 100 sideways such that both the nut 200 and the brake pipe 204 move out of the channel 118 through the cut-out 140.

The foregoing description of embodiments and examples has been presented for purposes of illustration and description. It is not intended to be exhaustive or to limit the invention to the forms described. Numerous modifications are possible in light of the above teachings. Some of those modifications have been discussed and others will be understood by those skilled in the art. The embodiments were chosen and described in order to best illustrate certain principles and various embodiments as are suited to the particular use contemplated. The scope of the invention is, of course, not limited to the examples or embodiments set forth herein, but can be employed in any number of applications and equivalent devices by those of ordinary skill in the art. Rather it is hereby intended the scope of the invention be defined by the claims appended hereto.

What is claimed is:

1. A wrench for hand tightening a nut arranged surrounding a pipe to assemble the pipe to a modulator, the wrench comprising:
an elongated body having a first end face, a second end face arranged opposite to the first end face, an outer surface and an inner surface defining an elongated channel extending from the first end face to the second end face, the elongated body includes
a first body portion extending from the first end face towards the second end face, wherein an inner surface of the first body portion includes a shape complimentary to that of the nut, and
a second body portion extending from the first body portion towards the second end face, wherein an inner diameter of the second body portion is smaller than an inner diameter of the first body portion defining a seat at an interface of the first body portion and the second body portion,
wherein
the elongated body defines a cut-out extending from the outer surface to the inner surface of the elongated body along an entire length of the elongated body to enable an insertion of the wrench over the pipe and the nut, and
a distance of the seat from the first end face is selected to provide a visual indication of completion of the hand tightening of the nut when the first end face contacts the modulator during tightening of the nut.

2. The wrench of claim 1, wherein the elongated body includes a third body portion extending from the second body portion to the second end face, wherein an inner diameter of the third body portion is larger than the inner diameter of the second body portion.

3. The wrench of claim 1, wherein the outer surface includes a knurled surface that extends from the second end face towards the first end face.

4. The wrench of claim 1, wherein the inner surface of the first body portion includes a hexagonal shape.

5. The wrench of claim 1, wherein the inner surface of the elongated body includes a first chamfer extending from the first end face towards the second end face.

6. The wrench of claim 1, wherein the inner surface of the elongated body includes a second chamfer extending from the second end face towards the first end face.

7. The wrench of claim 1, wherein the elongated body includes a skirt portion extending radially outwardly from the second body portion.

8. The wrench of claim 7, wherein a portion of the outer surface corresponding to the skirt portion defines a knurled surface.

9. A method for coupling a brake pipe to a brake modulator, the method comprising:
inserting the brake pipe inside a hole of the brake modulator with a nut, for coupling the brake pipe to the brake modulator, positioned over the brake pipe and outside the brake modulator;
engaging a wrench to the brake pipe and the nut, wherein the wrench includes
an elongated body having a first end face, a second end face arranged opposite to the first end face, an outer surface and an inner surface defining an elongated channel extending from the first end face to the second end face, the elongated body includes
a first body portion extending from the first end face towards the second end face, wherein an inner surface of the first body portion includes a shape complimentary to that of the nut, and
a second body portion extending from the first body portion towards the second end face, wherein an inner diameter of the second body portion is smaller than an inner diameter of the first body portion defining a seat at an interface of the first body portion and the second body portion, wherein the elongated body defines a cut-out extending from an outer surface to the inner surface of the elongated body along an entire length of the elongated body,
wherein the wrench is engaged with the brake pipe such that the brake pipe extends through the channel and the nut is arranged inside the channel and abutting the seat; and
rotating the wrench, by hand, to tighten the nut till the first end face of the wrench contacts the brake modulator.

10. The method of claim 9, wherein engaging the wrench with the brake pipe and the nut includes inserting the brake pipe inside the channel through the cut-out such that the nut is arranged between the brake modulator and the first end face.

11. The method of claim 10, wherein engaging the wrench with the brake pipe and the nut further includes displacing the wrench towards the brake modulator to insert the nut inside the channel and to position the nut abutting the seat.

12. The method of claim 9 further comprising disengaging the wrench from the brake pipe and the nut upon contact of the first end face with the brake modulator.

13. The method of claim 12, wherein the wrench is disengaged from the nut by displacing the wrench in a direction away from the brake modulator such that nut is positioned outside the channel.

14. The method of claim 13, wherein the wrench is disengaged from the brake pipe by removing the brake pipe from the wrench through the cut-out.

15. A wrench for hand tightening a nut arranged surrounding a pipe to assemble the pipe to a modulator, the wrench comprising:
an elongated body having a first end face, a second end face arranged opposite to the first end face, an outer surface and an inner surface defining an elongated channel extending from the first end face to the second end face, the elongated body includes
a first body portion extending from the first end face towards the second end face, wherein an inner surface of the first body portion includes a shape complimentary to that of the nut, and
a second body portion extending from the first body portion towards the second end face, wherein an inner diameter of the second body portion is smaller than an inner diameter of the first body portion defining a seat at an interface of the first body portion and the second body portion,
wherein
the elongated body defines a cut-out extending from an outer surface to the inner surface of the elongated body along an entire length of the elongated body to enable an insertion of the wrench over the pipe and the nut,
a distance of the seat from the first end face is selected to provide a visual indication of a completion of the hand tightening of the nut when the first end face contacts the modulator during tightening of the nut, and
a portion of the outer surface of the elongated body defines a knurled surface that extends from the second end face towards the first end face.

16. The wrench of claim 15, wherein the elongated body includes a third body portion extending from the second body portion to the second end face, wherein an inner diameter of the third body portion is larger than the inner diameter of the second body portion.

17. The wrench of claim 15, wherein the inner surface of the first body portion includes a hexagonal shape.

18. The wrench of claim 15, wherein the inner surface of the elongated body includes a first chamfer extending from the first end face towards the second end face.

19. The wrench of claim 15, wherein the inner surface of the elongated body includes a second chamfer extending from the second end face towards the first end face.

20. The wrench of claim 15, wherein the elongated body includes a skirt portion extending radially outwardly from the second elongated body, and a portion of the outer surface corresponding to the skirt portion defines the knurled surface.
